(19) United States
(12) Patent Application Publication
(10) Pub. No.: US 2022/0406475 A1
(43) Pub. Date: Dec. 22, 2022

(54) Method for dimensional manipulation

(71) Applicant: GREGORY M FRIEDLANDER, MOBILE, AL (US)

(72) Inventor: Gregory Marcus Friedlander, Mobile, AL (US)

(21) Appl. No.: 17/770,068

(22) PCT Filed: Oct. 30, 2020
(86) PCT No.: PCT/US20/58333

§ 371 Date: Apr. 19, 2022

(51) Int. Cl. G21B 3/00; G06N 10/40

(52) U.S. Cl. CPC G21B 3/00; G06N 10/40

(57) ABSTRACT

A method for manipulating fractal forming information, also referred to as ct states, in a dimensional form of increasing and decreasing fractal compression roughly generated by the denominator of pi (fpix), n+1, and the formula 2f(x)\hat{ }(2\hat{ }x) including transitional steps between those stepwise increases and decreases by altering the compression of decompression targeting fractal states of the composite dimensional features (next lower dimensional features) or the resulting dimensional features (next higher dimensional features). Steps include identifying the ct states which are to be manipulated, select a compression or decompression ct state component to change the selected ct states, adding the compression or decompression components to yield the new ct states.

### PRIORITY STATEMENT

Priority of patents, all incorporated herein by reference, is hereby claimed (listed in the PCT Request)

### 1. BACKGROUND OF INVENTION

Energy represents our ability to control, within a range, pre-time changes to speed up and slow down those changes relative to time which arises gradually.

### DETAILED DESCRIPTION OF THE PREFERRED EXEMPLARY EMBODIMENTS

The group of processes include identifying the ct states which are to be manipulated, selecting a compression or decompression ct state component to change the selected ct states, adding or removing the compression or decompression ct states to yield the new levels of compression, controlling time to control pre-time change ct states within the matrix, quantum computing, determining probability of state changes, identifying qubits based on ct features, identifying qubit pre-time states, pre-atomic fusion, atomic fusion, atomic manipulation, molecular manipulation, post molecular material manipulation; identifying or changing force features; changing multi-dimensional fractals of different fractal compression states within the matrix; changing base states where fractal is made of a plurality of base states, ignoring dimensional curvature in favor of fractal qualities of the matrix; targeting relationships between the pretime and post-time features, controlling ct states, targeting at least two ct states sequentially.

Atomic Fusion general steps: (a) determining the reactants to be used. Hydrogen and a neutron donor which can be combined. H2 (heavy hydrogen) heavy water (Deuterium or D), Li-6H; (b) changing the ct state structure by adding or removing different ct states or transitional states in order to (c) expose the nucleus protons 67 and (d) encourage the neutrons 30 to close and (e) stabilizing the resulting neutron backbone with protons and electrons.

Energy disrupts the stability of atoms, we can counter it based on obtaining a balance of the ct states, creating a stable radioactive decay.

Inherent in the process is the step of treating accumulations of the quantum fractal features and not fields.

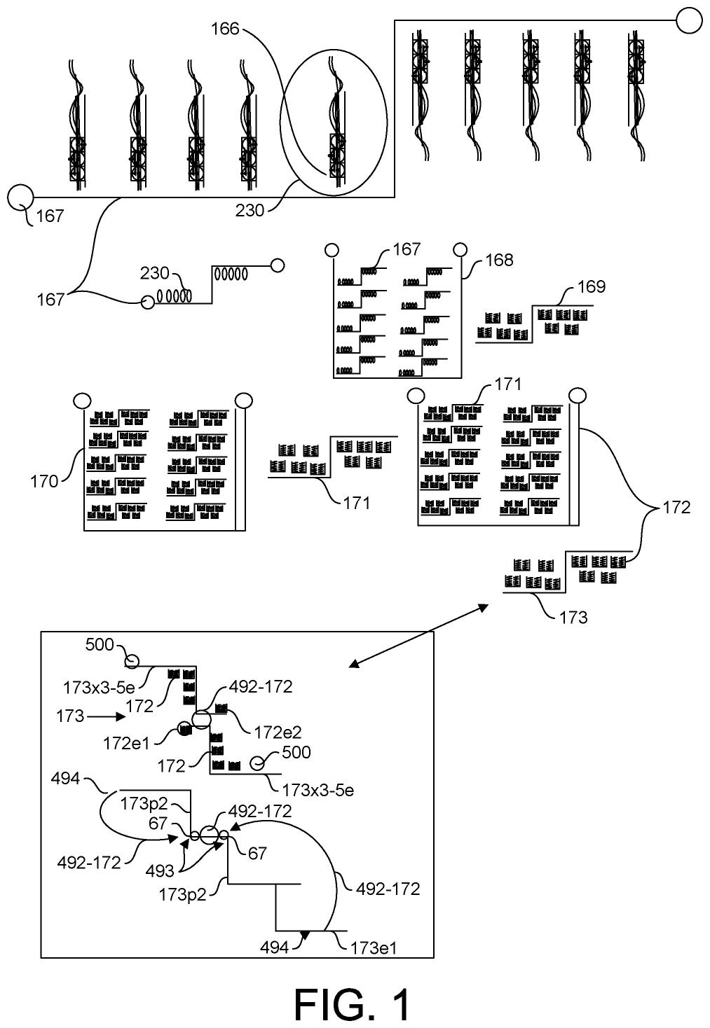

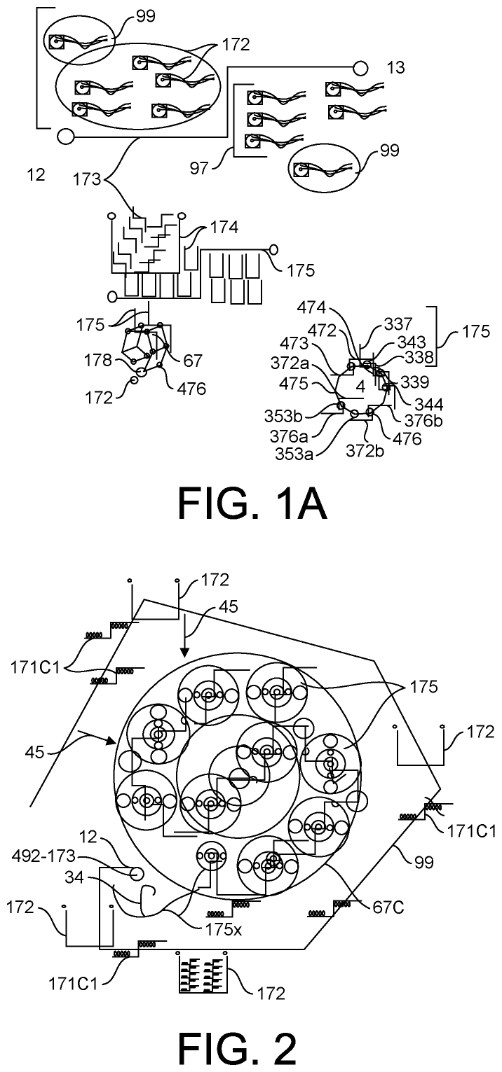

### Atomic NEUTRON FUSION FIG. 1

There is a larger transition which takes place as the proton 67 collapses into the neutron base 10 state shown in FIG. 1 and FIG. 1a. The information necessary to stabilize the proton 67 is reflected in the unstable ct4t15 spiral cloud 178. Information within the cloud 178 is released upon collapse as the energy of the proton forms neutron fusion.

By targeting the changing geometries and different absorptions and spews which balance the transition, the reaction can be based on quantum features instead of the false energy component.

For a neutron 4 to form, the paired 5-5 Proton folds into a base 10 state. For the reaction to be complete, the neutron must be balanced.

The ct4t15 (10 ct4t15 states less one ct4t12) unit proton to a ct4 state occurs an inflection point between the ct4t15 and next lower stable fractal, the ct4t12 which in turn relies on the next lower fractal all the way down to the ct1 to ct2 transitions.

Since this is a fractal model, this inflection point can be calculated, corrected for compression and base state in either direction.

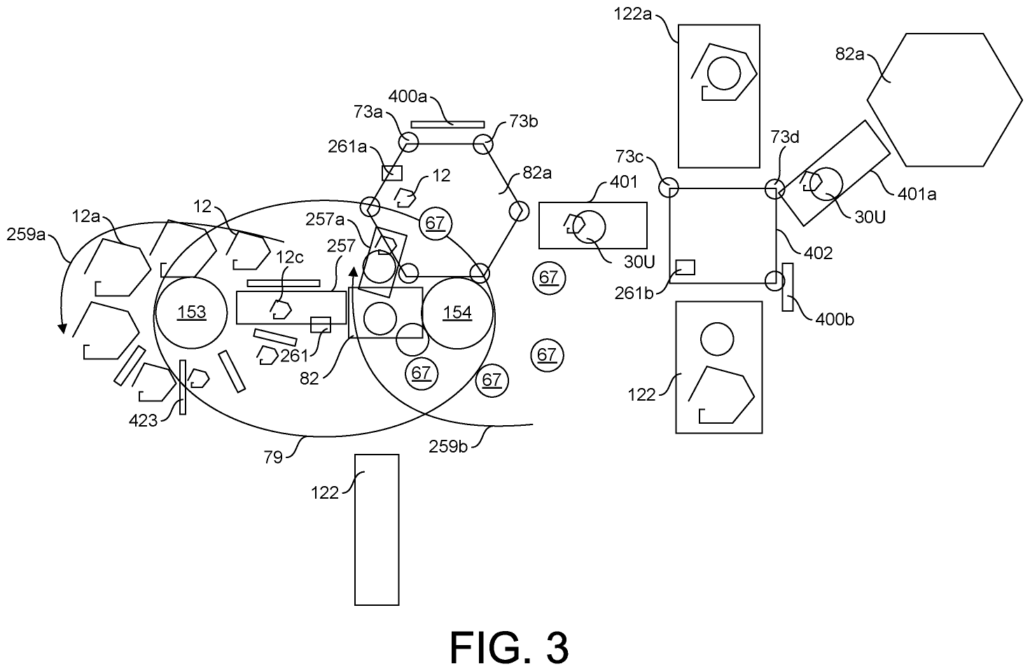

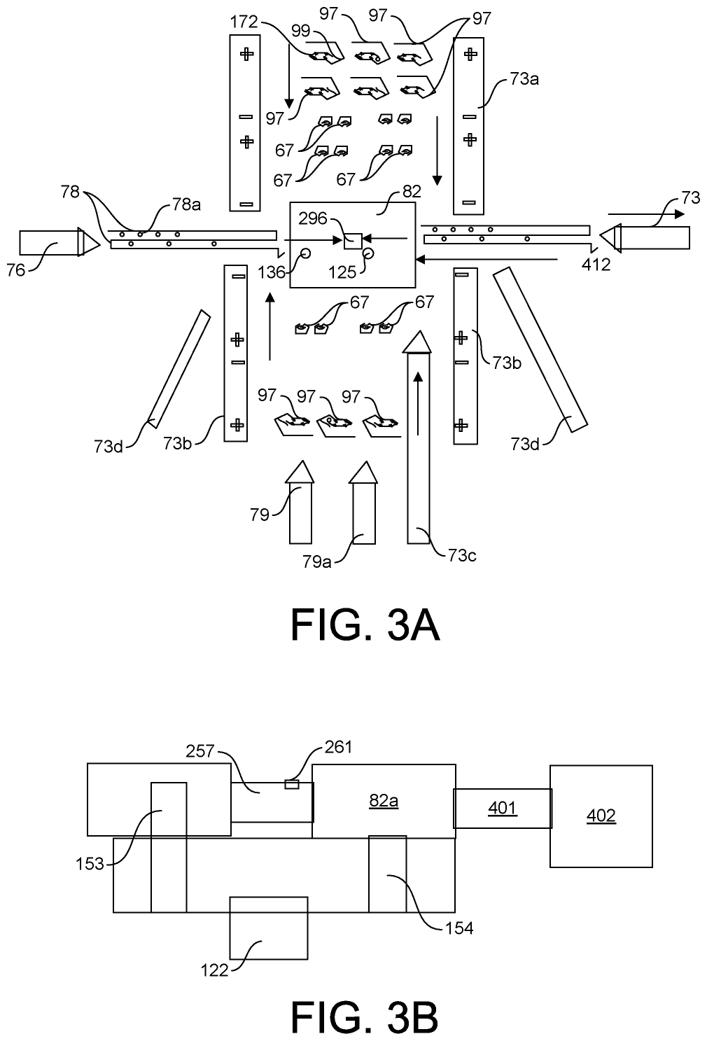

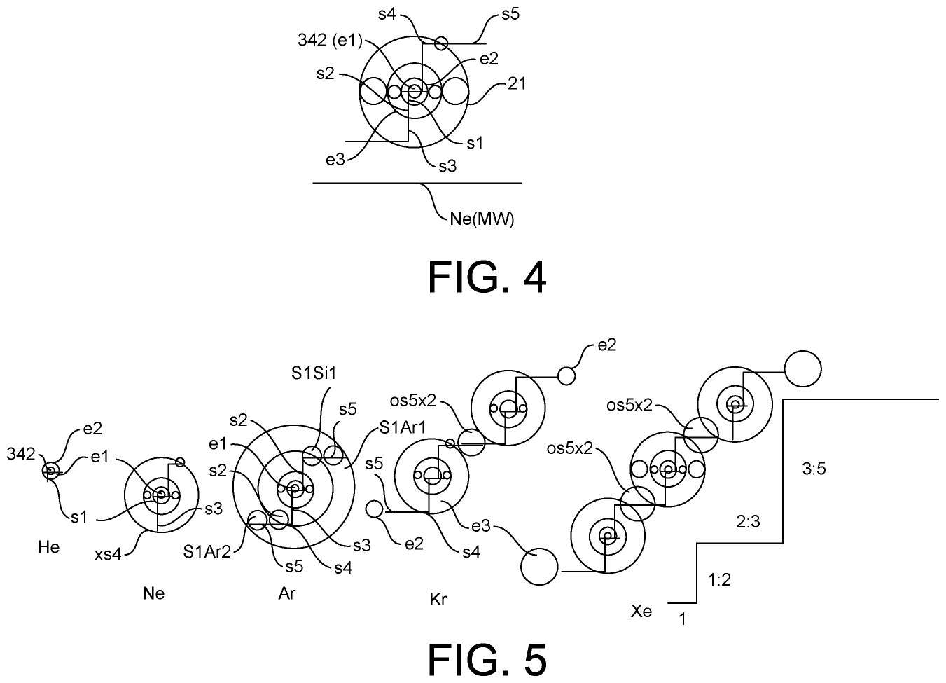

The folding results in balancing arm 472 overlapping with opposing arm 473. There is also a shared information web 474 between the highly wound arms of the 10-sided structure 475 made up of base 3 stable T15 states as a series of base 10 neutron centers, 3 of the 10 such centers are labelled here as 353a, 353b, 476. This web 474 keeps out charge sharing but allows lower ct states (viewed as space) to enter and exit. Before the final step of folding, arms 472 and 473 would look more like items 372 and 376 of FIGS. 3 and 4. The dimensional collapse creates a fractal, mesh like cloud of information that keeps the neutron from absorbing ct12 material and limits the absorption to lower ct states that don't exhibit charge characteristics; explaining how the neutron holds the atom together and forms a backbone which supports the proton periodic table.

Around second neutron center 353a there is neutron first offset spiral 372a balanced internally to the neutron with neutron second offset spiral 376a. This is repeated for a second center of neutron shared information 353b about which there is a second neutron offset spiral 372b and a second neutron second offset spiral 376b, and so on to form a 10 unit ring forming the collapsed neutron.

The narrow language is: a process for dimensional manipulation comprising the steps of (1) defining dimensional features as ct states defined by at least one iterated equation which separates compressing ct states from decompressing ct states wherein compressing is towards higher dimensional features and decompressing is the movement from higher dimensional features to lower dimensional features; (2) identifying a matrix containing a plurality of “ct states” and (3) changing at least one ct state to alter at least one dimensional feature of the matrix.

Compression comprises balancing compressed ct states on a fulcrum comprised of shared lower ct states from at least two higher ct states as Fibonacci series spiral solutions of the at least 2 compressed ct states and targeting the various fulcrum, connector, f-series and compression features to stabilize or destabilize compression states. Fission occurs at any compression level and not just that seen in heavier elements by targeting these features.

Balancing comprises a series of fractal separated successively lower ct states around the f-series spiral solutions of successively higher compression lower ct states to balance the compressed higher ct states.

Balancing may be defined by balancing absorption of spew of ct states between compressed ct states and targeting comprises targeting the absorptions and spews of the matrix, targeting shared information between compressed states, or targeting both.

Balancing along a fulcrum spirals further comprises (1) defining the electron shell as a third outer spiral, balanced on inner spirals of a proton outer shells as a second outer spiral, around the neutron cores sharing information as a fulcrum between the two neutrons and from which extends the first inner spiral to form and stabilize a neutron core in a molecular fusion reaction.

Balancing comprises opening at least one of the spirals using plasma to allow a higher compression state to get within the at least one spiral.

Balancing comprises creating conditions to encourage balancing with a mix of ct states.

Balancing comprises determining a set of resulting ct states desired, determining a plurality of reactant ct states based on the resulting ct states; and changing the reactant ct states to obtain the resulting ct states.

The ct states at the level where energy becomes apparent are treated as a transition between pre-time ct states and post-time ct states and manipulation is done by treating time as change in the pre-time ct states viewed from the post time ct states. One result is that you can treat energy as pre-time dimensional change within the matrix to get desired results.

The types of changes for manipulating come from the group comprising removing ct states (as for observation), compressing, decompressing, increasing various ct states and ct states with different fuse lengths relative to the point of change within the matrix (as by combining two matrix), changing the net fuse length of the matrix, changing the absorption of the matrix, changing the spew of the matrix and identifying a ct state as an identified ct state within the matrix and changing the ct states making up the identified ct state.

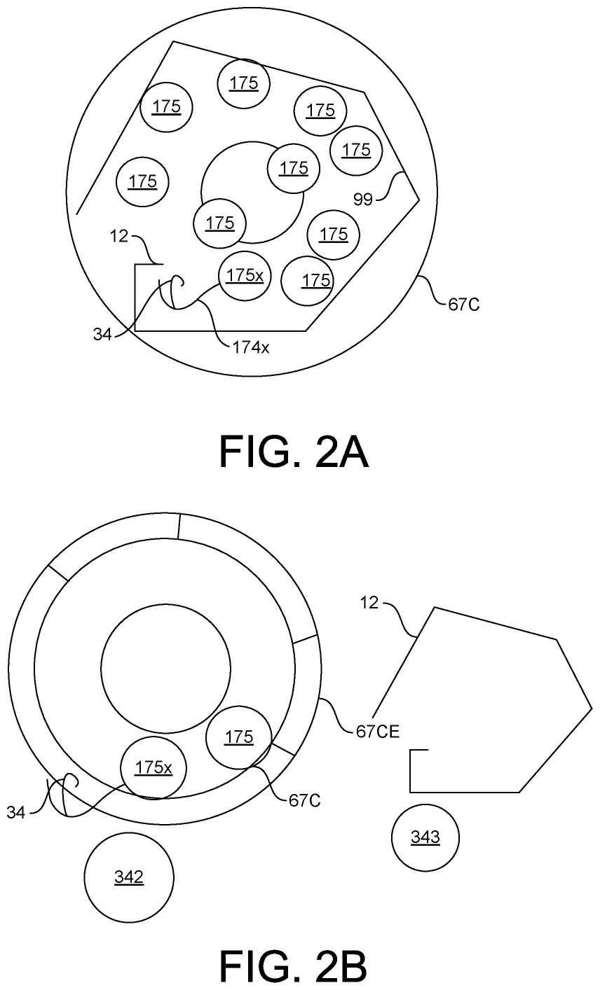

### Ct3-4 Fusion FIG. 2

While fractally similar, ct3-4 fusion involves a transition from ct4t15 states 175 to ct4 states. Here those 10 ct4t15 states 175 within a proton core 67C are shown modeled after atoms with Neon-Argon Cores as discussed later. One of these ct4t15 states 175x is broken so it extends out of the proton core 67C of the proton 67. The portion extending out of the core 67C includes positron 34. This positron is balanced by an electron 12. The positron 34 is shown more tightly wound by the increased absorption (not shown) of ct4t15 state 175x.

The primary component states of electron 12 are t12 states 172. While pulled in by absorption 45, the series of t12 states 172 and cloud of t11 states 171 are loosely engaged with the proton 175x can extend out as a single spiral arm shown here as bundle 99 pulled in by net absorption 45.

The shared information 492-173 is separated here from the proton and electron. In this view it is easy to see the difficulty of stuffing the electron 12 and its bundle 99 into the core 67C in order to effectuate a ct3-4 fusion reaction. Given the expansion of t11 states 171C1, even components are enlarged due to unfolding.

Pre AuT fusion shows 2 hydrogens combining to make a Helium yielding a positron and an electron. This figure shows where that positron and electron come from, they exist together in any balanced atom.

FIG. 2A shows where the core 67C has been expanded by adding information to a near plasma state with associated dispersion of the component items 175. Were this possible, removing the excess added information could pull in the electron and positron.

FIG. 2B shows where plasma has separated the proton which now has the original shell 67C and an expanded shell 67CE because of the plasma and the electron 12 is separate. The plasma state is balanced with shared information 342 and 343 which serve to separate and stabilize the separated proton and electron.

### FIG. 3

FIGS. 3 and 3b shows one method of using this model for manipulative change, particular to pre-atomic ct3-ct4 fusion, but applicable to all changes through fractal modification. This shows a reactor which begins by creating a plasma from hydrogen gas in the fashion known in the art and feeding it as positively and negatively charged electrons 173 and positively charged proton/positron elements 67 and these are rotated in a way that allows them to interact around oppositely charged poles.

A charge concentrator means is used to compress the electrons which are then fed into an accelerator means which accelerates them to the separated protons. Increased speed, observation and other energy and vacuum (ct1-3) stripping techniques can be used to minimize the size, including using streams of high concentration photons or the like to attempt to create electrons with the best chance of combining with the positrons and this includes an environment in the reaction chamber to encourage this.

The combined electron and proton pairs are then sent to a reaction chamber 266a where they are temporarily combined into unstable neutrons which, being uncharged, can be filtered out, here by filtering by momentum means using the lack of charge and increased mass to escape the charge about which the protons are rotating and into a stabilizing chamber where they can be bombarded with protons and electrons as plasma and possibly as cooling stabilized hydrogen. Where necessary to maintain concentrations, multiple units can feed into any chamber, here two reactors feed into a common stabilizing chamber.

Sensors can be used in this process to determine when to activate the various elements. A heat sink means, such as a boiler, can be used to draw off the energy from the process.

Electromagnetism can be used so that a core of mostly electrons and an outer shell of protons exist to interface by spinning the two relative to one another to attempt to get the first stage of the reaction.

To get concentration of hybrid expanded protons together to form 2 neutron pairs, neutrons can be put into the system as with deuterium or tritium with plasma expanding cores protected by protons and electrons to allow the neutrons to come together from as many angles as possible with or without rotation and counter rotation using off set intersecting lines or electromagnetic rotation.

The inner core of the proton needs to have the components expanded without destroying them.

Show the shared information working with the two, maybe not having them interlock as much as is shown in the first view. Note that a break in the proton core occurs where the open t15 extends outward, that may be viewed as a bubble of the core with the positron in the bubble and the electron out of it in various degrees.

While this uses an atom type arrangement and shows the pairing with two arms, this is a fractal design that can vary somewhat and the underlying component states are not shown, nor is the t12 makeup of the shared information shown in detail since this purpose is to show the process that has to be carried out to get the merger. Stabilizing the merger is shown as with the oxygen, but with just a pair of neutrons, pair of protons and pair of electrons in this simple model.

This means we need to show the opening at least one more time, possibly turning the core to a partial or full plasma state to allow it to be expanded to inject the second stabilizing neutron.

To accomplish this the primary reactants, protons and electrons must be brought into a reactive environment, where there is push from the outside states and pull from the interior to the proton core 67.

Since the electrons need to be made absorbable, they are separated from Hydrogen atoms and compressed, decompression will draw information. While the theory holds, whether the protons need to be compressed or decompressed and electrons can be subject to experimentation, although expanding protons initially should create a better environment to receive compressed electrons. Electron components

Hydrogen plasma generator 122 injects plasma of protons 67 and electrons 12 into stripper chamber 79 where flow control means 259a rotates the electrons around inner magnet 153, a positively charged magnet, and flow control means 259b rotates the protons around outer magnet means 154, a negatively charged magnet. Here Electron 12 can be see expanding into electron 12a.

At least one of the electrons 12 passes through at least one compressor means 423 which shrinks the electrons into a compressed electron 12c. Sensors 261 can be incorporated to activate injector 257 to send the electrons into contact with at least one proton in a first reaction chamber 82 from which a second injector 257a sends the pair or pairs of protons and electrons into second reaction chamber 82a where an environment is maintained or varied to encourage their combination by reaction drivers 73, exemplified by 73a and 73b in conjunction with the method taught herein as by physically altering the interior with magnetically shaped fields to sequentially mimic the compression shapes, mixing the relative concentrations of each, lasers to physically force units in the interior together, electromagnetic field generators positioned to change the fields dimensionally, to provide swirling eddies to rotate the electrons, protons around each other or the neutrons (in the same manner as shown with item 79 and the like.

To get inside other shells, more compressed states (perhaps using states with more even exponents such as ct4t12 and t14 may be used. Open states like t11 and t13 can be used to push reactive elements around, to spin them, for example, by creating a spin of the open states.

Multiple injectors 257 or 401a may be used to increase concentrations of reactants in reaction chambers 82 and 82a. This is exemplified by having a the third chamber 401 and a second third chamber 401a from a second reaction chamber 82a to feed multiple neutrons or neutrons from multiple areas into loading chamber 402.

A heat first exchange chamber 400a can draw off energy from the reaction in chamber 82.

Unstable neutrons 30U are carried by third chamber 401 into a fourth loading chamber 402 where the single neutrons are stabilized into pairs with proton and electron shells from either plasma generator 122 or cooling generator 122a. A third reaction driver 73c and fourth reaction driver 73d encourage combination of the neutrons just as drivers 73a and 73b drove the electron to proton combination. A second plasma state to open the neutrons might be in order as part of the operation of items 73c and 73d. Free neutrons can encourage either combination. While separate chambers are shown, having the entire process as a single event, essentially carried out sequentially but continuously is more likely.

Timing and change can be reconciled by determining the amount of energy and equating it to pre-time change within the system to creating net views of pre-time change. The subatomic structure can be manipulated with other subatomic fields, here shown with. There is an organization of the t12 states 172 and dispersed t11 states 171 which can be changed and then allowed back to monitor net pre-time effects. Recycling lines 125 can be used to reintroduce reactants into the chamber after they are removed by vacuum line 136 which can selectively draw them out so that the pulsed plasma using items

Manipulating the features to be observed by sensor at rest and charged with other information can be used for manipulation using comparative quantum generator means for lesser or greater information states. This can be done by compressing the electron while removing the information which separates the ct4t12 states from one another. Modeling shows that the compression of the ct4t12 states to shared information along a ct4t13 includes closing ct4t11 states within ct4t12 and aligning them along f-series spirals. Expanding and contracting spiraling is observed in nature, it is possible to get the same effect by staggering energy or stepped chambers 1, 3, 5, 8 (3,6,9), (5,10,15), along with or in addition to actual spiraling.

FIG. 3A shows another approach to this design, in this case focusing on synthetic diamond production.

In this case a first reactant 78, typically Li6 for atomic (ct4-ct5) fusion and layered graphite here with metal shavings 78a, is delivered in quantity using first source driver 76 (lasers, presses, etc.) oriented to push first reactants together, at different angles if spin induction is a goal. A plasma pulse canon means 412 for generating a plasma to separate neutrons, protons and electrons can be used as discussed hereinabove, and in this case as a microwave generator can plasma the shavings 78a to allow the surrounding layers of graphite as the first reactant 78 to become more reactive.

Flow control means 259 can be used to draw out at least some of the protons 67, electrons 12 or other products (not shown) of the reaction to maintain an environment conducive to the desired reaction. At least one reaction driver 73, 73a, 73b, 73c and 73d serve the purposes of shaping the reaction, pushing different elements like protons 67 or electron shells 97 or electron bundles 99 into or out of reaction chamber 82 to drive the more isolated neutrons together in the desired geometry and with the desired rotational symmetries.

Diamond manufacturing brings six sided features close enough for neutrons to share absorption and spew, the less offset the stronger. The fusion model suggests that it is possible to use the fusion plasma method. This design would be with a dusting of metal (iron) atoms to create plasma in a microwave field followed by the application of mechanical pressure of same type used to get lithium x to fuse.

The plasma exists only to open the shells for greater compression. In this case feeding sticks of the graphite-iron mixture into microwave field plasma reactor to both compress (if the feed is from both sides) and continue the process of diamond manufacture as to size. While this method focuses on graphite, this conceptual framework can work with any reaction, varying reactants and the nature of the activation to get different effects.

The units may be targeted for any material manipulation but the shared information has to be concentrated toward the matching size of the cooperating atomic or molecular fractal shells and bringing these together whether using the electron-positron relationship, or another fractal relationship to bring different ct states together.

### Process FIG. 3c

The transitional nature of the reaction is shown in exemplary form in FIG. 3c. At least one first contact means 379 for generating a plasma or plasma arc. In this case there is a two-pulse plasma 459 targeting the atomic level as six sided in this example maintained by at least one plasma cannon 433 with plasma accelerated into the reaction by at least one electromagnetic accelerator means 455. At this point there is a compression step 460 followed by separating out reactants 461 from 462 transitioning from a six sided targeting to a five sided targeting 463 where the separated 10 sided reactant 457 is brought back in with a channel means 456 aided by at least one second electromagnetic accelerator means 455a followed by the addition of a six sided reactant 458 via a second channeling means 456a aided by a third electromagnetic accelerator means 455b to get the ten sided reactant 457 within the six sided reactant 458 which may be subject to spinning compression 464. At least one shaped charge means 387 to a shift to 8 sided geometry at inflection point 465 after which at least one expanding means 458 uncompacts the reaction all along a line of reaction means 421 for defining the line of reaction, possibly following the plasma generating means.

The exact nature and steps of this reaction will vary with experimentation, the key element being that it targets the many targetable features including dimensional shape at the atomic level and the shifts in dimensional state, absorption and spew and the related rotational symmetry and balance, concentration, time of reaction, number of actual dimensional transitions of various reactants, purities of reactants and the resulting purities and separations within the steps of the reaction, voids and the makeup of those voids (amounts of ct1-3 and beyond), separations by plasma, electromagnetic means, pressure, heat, volume and the like, compression by the same features, barriers, and the precise series of steps and pauses.

This reaction focuses on the reaction of six sided features to 10 sided features to the possibility of an 8 sided geometry allowing the transition first to a 10 sided neutron from a possible mixture of 10 sided neutrons and protons (not shown) to neutrons which are ultimately paired and stabilized with other reactants.

In this example, targeting of six sided features is followed by separating, the primary role of Plasma, then 8 sided, five sided, six sided back to 8 6 and 5-sided expanding six with compressed 10 and the 8 sided transitions are all targeted. This shifts from a coarse pummeling of features to attempting to manipulate the reaction and dimensional shifts.

### The Periodic Table of the Elements FIG. 4

The neutron absorbs the lower fractals of space and spews the higher forms pulling both the protons and electrons into more circular orbits from pure spirals giving movement and pretime change, interpreted as energy, to the atom. Common spew and barriers in size from neutrons, electrons and protons gives these specific states stability over others.

This ensures that they force apart like states common absorption pulls them together. This function of absorption and spew along f-series change and 2\hat{ }n compression/decompression establishes the observed and mathematically displayed orbitals for both protons and electrons. In this way the model shows the atom combination as a function of stabilizing neutron absorption and spew.

Modeling Chemistry and physics based on this model leads to significant efficiencies and better predictions of reactions.

All forms of space, energy and matter (dimensional states) are formed of lower dimensional states and collapse only at full ct levels (ct1,2,3 (spatial states), ct4 neutrons and ct5 black holes).

### Compression, Spirals, Outliers, and Bridges

The fractal structure is made up of two parts.

The F-series expansion for each is shown, but only the f-series for el will be discussed for the atom initially.

In AuT the ideas of spin in the electron sense are eliminated because electrons are spiral clouds of information with shifting centers of pre-time change.

### FIG. 5

An examination of this relationship led to the overlay of the f-series spiral over 2\hat{ }n compression.

A measurement of the results yields the predicted Neutron Backbone in surprising detail. The lengths of the “s-arms” define areas for holding neutrons, not the neutrons themselves. A detailed analysis provides insight into what is observed.

Deviations in precise results in combinations of the higher orders of compression of the PTE, and in protons with elements with higher atomic numbers, is considered acceptable given the cloud like structure of all ct states (ct1-ct4 being applicable here) in AuT modeling. how much of each type of information is in an area of a matrix; in a length, area or volume and designing the staged matrix based on the interaction of the different area, putting these together in an order to get the desired interactions.

The incomplete fractal structure of carbon turns out to be critical in understanding the PTE, because the erratic nature of the neutron count at Xenon (77 neutrons). Xe appears to have an odd number of neutrons until one realizes that the “outliers” stabilizing Xenon are Carbon. 2×5.5×2 gives 11 neutrons which allows Xenon to remain consistent with the other backbone pairings while still having an odd number of neutrons based on pre-AuT ideas of what Neutrons look like.

The circles are designated as e0-ex and the lengths of the F-series spiral are designated as s1-sx. E1 occupies a unique place as the initial “fulcrum” of shared information about which the atom is balanced and is designated alternatively as shared information 342 which is explained in more detail in the earlier papers.

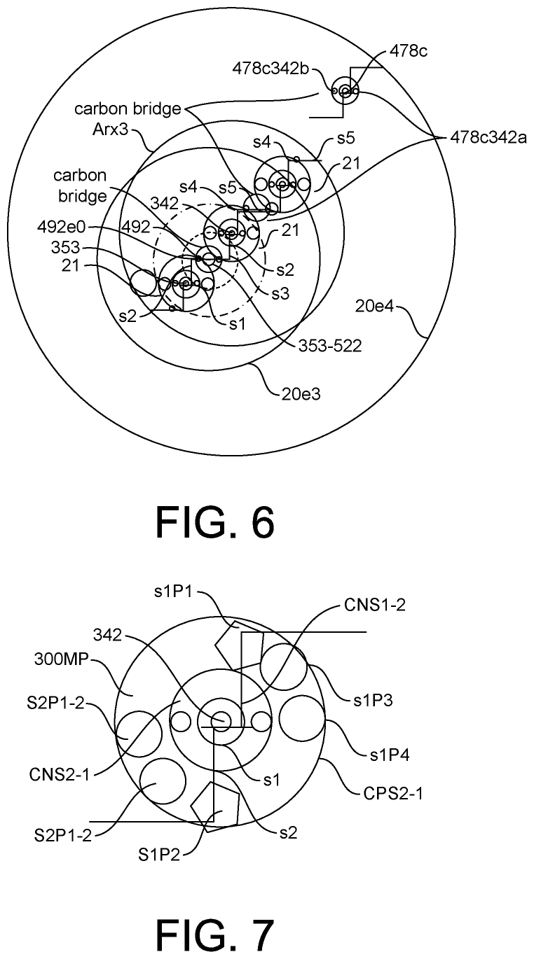

### FIG. 6

Targeting bridges and outlies allows for more careful control of chemical reactions, fission and fusion. Each feature such as the argon or He or C outlier or the “8 unit bridge” of S5 overlap would absorb different energies (ct4 transition states) preferentially allowing for these features to be targeted or monitored just as smaller ct states can be targeted.

For this reason, consideration of all bridge alternatives within the fractal model must be considered both as intermediary and final arrangements and this carries over into molecular interactions.

Likewise, the placement of the s states, transition between them, the “free arm” forming overlapping bridges or outliers and the like all provide targets for manipulation at every compression state.

This fractal model makes it possible to model and control pre-atomic, atomic and molecular interaction based on the manipulation of the larger elements and the smaller elements. If for example, one changes the concentration of one fractal element in a solution, the stability of the mix within the solution is destabilized or stabilized and targeting the elements of the matrix can be used to have large units affect the small underlying units or to have the small units change the larger units along the common mathematical paths disclosed herein.

Targeting the fractal features (outliers, base units, bridges, free ct states, etc) and the tendency of balance and effects of unbalanced system around the fractal results, whether building or tearing down is a major predictive and manipulative feature of the model.

The transitions between pre-atom, atomic and molecular interactions are also locations that can be targeted, in this case breaking down space by pulsing time and fractal qualities and concentrations to mimic the underlying fractal qualities being targeted to be changed or constructed.

The change in the number of photons not only changes mass but the center of gravity of the electron forming the higher state of energy. Instead of the electron moving, the entire spiral shape of the fractal curve is shifted outward. The photon “energy” is preserved because the photon is attached to the chain of information forming the electron just as the electron is loosely connected to the protons by absorption and spew. The fractal nature of the resulting math adding T6 or T9 composite photons ensures that the energy states will tend towards set jumps in which are in the standard model attributed to spin and orbital energies, orbital energies being the equivalent of fractal stable increases in size.

Instead of the electron moving, the entire spiral shape of the fractal is shifted outward. The photon “energy” is preserved because the photon is literally attached to the chain of information forming the electron.

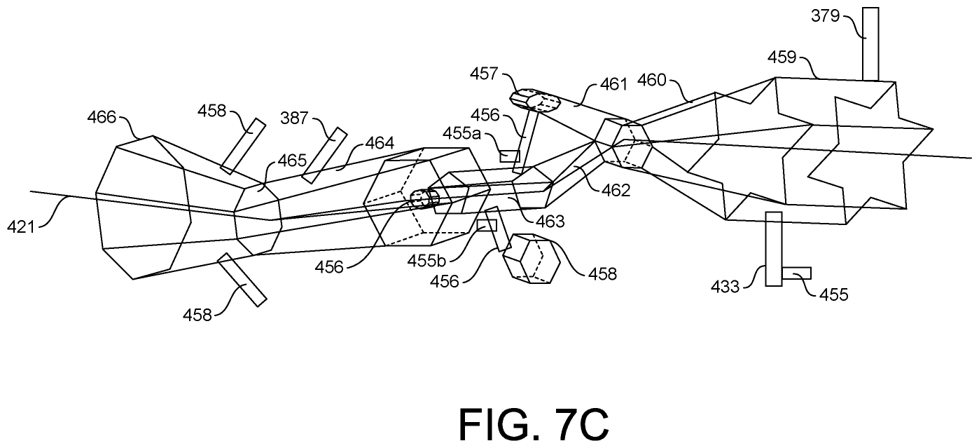

### Carbon the MAGIC Noble Carbon FIG. 7

In AuT you have the 6:6 carbon (proton to neutron); but equally important you have the 5.5 AuT orbital model.

FIG. 7 shows to carbon spiral backbone, exemplified by s1 and s2 with 6 carbons.

Carbon is an unstable noble hybrid in AuT. CNS1-1 (shown as five sided to differentiate it visually to correspond to its closer relationship to the extending spiral arm) is the outer neutron shell of S2, the carbon shell which includes the S1 Helium shell, marked by CNS1-2. Outside of this is the Proton shell 300MP for the Carbon, CPS2-1 which has room for approximately 10 protons, slp1 and slp2 for the Helium s1 core and s2P1-4 for the s2 shell neutrons.

There is insufficient absorption by the 6 neutrons in the core to hold more than 6 carbons.

Being attached to protons, the outer electrons are broken into two groups, the s1P1-2 group and the s2P1-4 group, but the s1 group is one on either side of the core, just as the s2 group is broken in half on either side of the core. S2-Carbon—up to 5.5 (6) Carbon.

In AuT the pairing of the electrons and the structure result from fractal features. Assuming the outer shell of electrons can hold 10 electrons for carbon, a fair amount of instability is tied to having an incomplete outer shell. Balanced neutron backbones are marked by the necessity of stabilizing the structure or destabilizing it for reaction by manipulating the balance of protons is seen in this view. Expanding the shell to allow for stabilizing features to fit or to allow destabilizing features to enter can occur at any stage and mark the differences between electromagnetic where t-13 features are affected, weak forces where the proton to neutron absorption and spew are affected or fusion where the bond between neutrons are affected, but all of these are fractal equivalents.

The modeling allows for a jig-saw puzzle approach to chemistry using these fractal relationships.

Carbon has these odd, open spaces which odd adhesive qualities that make carbon steel work and probably extends to silicon; check other features for same effects.

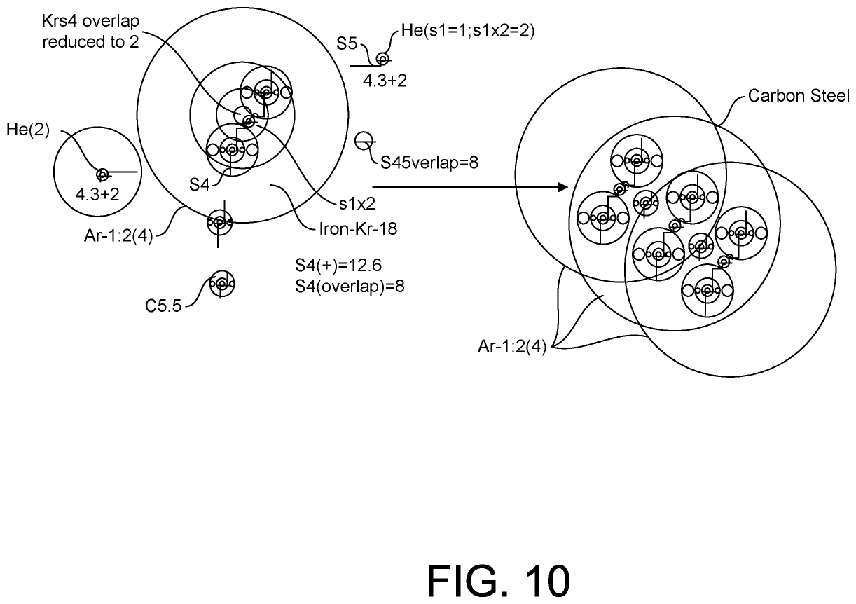

### FIG. 10

FIG. 10 shows one model of carbon bridging in Carbon steel showing the alignment of one atom with the absorption or spew characteristics of another strengthen the bonding modeled on fusion fractals. The design shows greater alignment of the bridging between iron atoms ends which is closer to the modeling of the fractal arrangement of higher order atoms and shows how this can occur. The process can include determining how these partial features exist and how they can be changed.

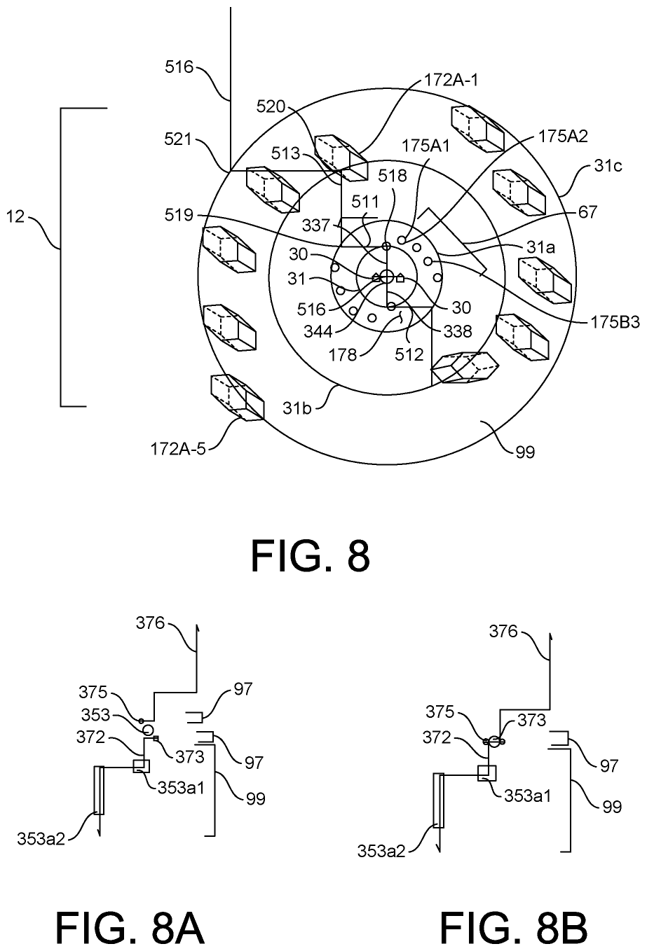

### FIG. 8 Spiraling t12 States

Electron 12 and proton 67 spread out within a circle reflected by bundle 99, here a bundle of two electrons. This shows how the electron t12 states are pulled into a more circular orbit around the t15 states of the proton. As this folding becomes tighter, the transition to a neutron occurs. The broadest method for fusion or controlled fission would be to encourage this folding or control this unfolding respectively.

Odd/even exponent results suggest that at odd exponents there would be expansion and there would be a partial collapse at even exponents but without dimensional change reflecting the cutting out of exchange of intermediary states.

### Balance FIGS. 8a and 8b

Figure aa uses hydrogen (H2) to show balancing reactants using the combination of fractals pairs with overlapping spirals.

This is an idealized view of the H2 layout and hence bundle 99 and electron shell 97 are shown as they generally would appear mathematically as two protons 375 and 373 approach.

Absorption and spew lead to the balancing arms, arms 372 and 376, presumably with increased dispersion of information towards the end farthest from the protons. This balancing required by the sharing of information and reflected as rotational symmetry gives rise to both dimensional perspective as well as molecular and atomic bonding symmetry

The effect of information gradually dispersing along the spiral arms is reflected in momentum reflecting the absorption and spew and resulting rotational pair stability of lower compression states on the higher compression states as they spread out, pushing it from the ends of the overlapping spiral states.

In a decompression reaction, the shared information breaks up the two reactants.

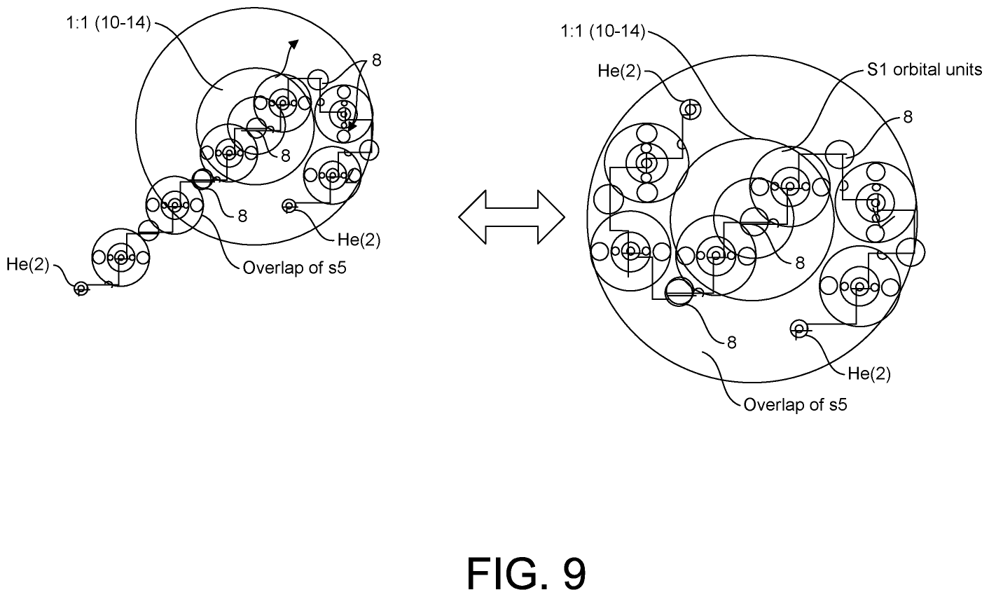

### FIG. 9

FIG. 9 shows the process of FIG. 8 applied to a larger atom, here Radon.

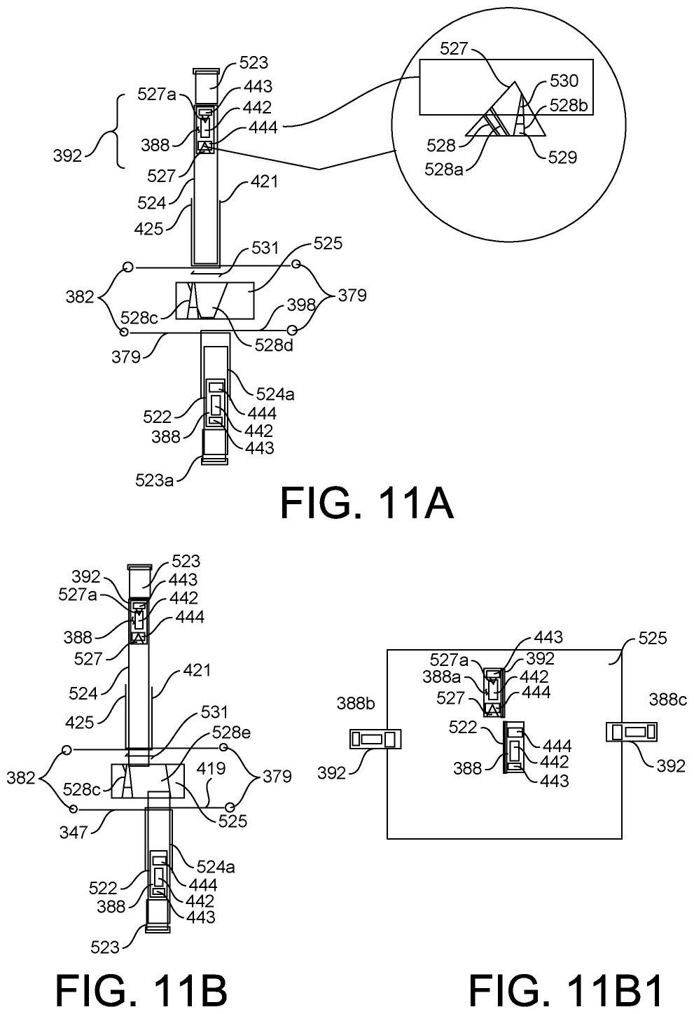

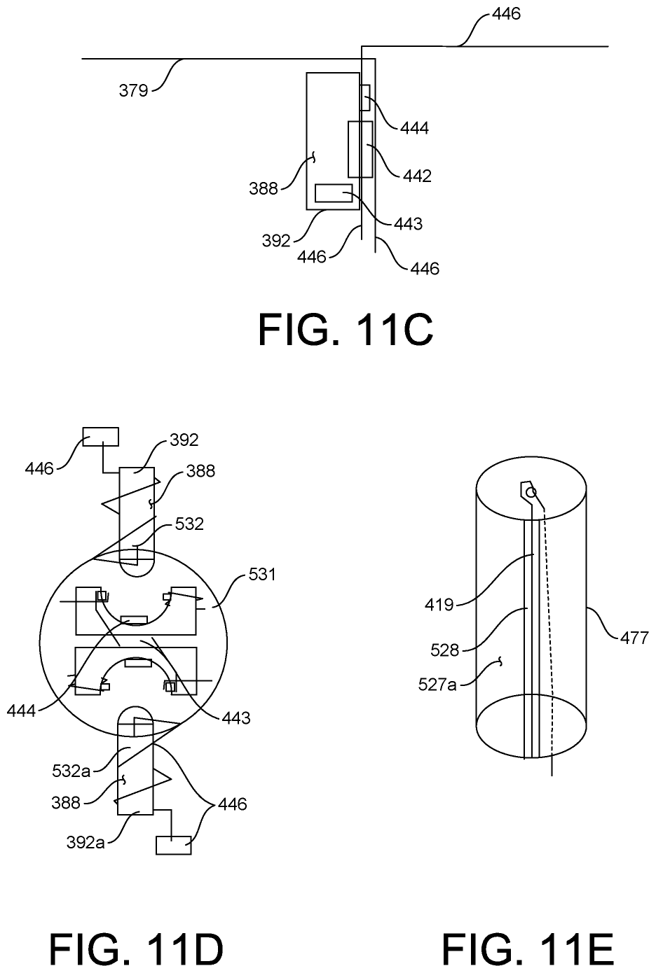

Plasma Pellet Model FIG. 11a-11e

FIG. 11 shows at least one first contact means 379, in this case a wire hooked to a microwave generator (not shown) for generating plasma when in contact with at least one second contact means 382 which is a wire attached to the other lead of the microwave generator (also not shown) for generating plasma in the manner known in the prior art. The area of the plasma generated covers a great deal of a plasma core means 390 for generating a reactive fusion material, in this case means 390 is a Li-6.

A first shield means 424 separates the plasma reactants. Means 424 is a destructible barrier which effectively dissolves when the plasma from the plasma heated core means 390 reaches means 424. Here there is a separation between the inner wall 424a and outer wall 424b of means 424 to provide a scaled separation to mimic fractal changes desired.

Inside of the shield means 424, embedded within insulating means 381 is a proton enrichment means, here second reactant layer 445, possibly hydrogen. There is a second compression means 423, which may be an explosive reactant mix. The entire pellet 392 is held within a second shield means 438 which is a harder shell to partially contain the explosive reaction between core means 390 reacts with the second reactant 445.

The arrangement is one where absorption and spew are targeted. When we say Li-6H explodes in contact with water, we are talking about a shifting matrix, not the bulk relationships of pre-AuT physics. Hence a shaped dimensional change is desired. For this reason, the core means 379 has a base six shape and the second reactant a base 5 shape. The interaction of the wires, the charge, the resulting plasma, the effect of the macroscopic features on the microscopic features define the process.

While the core means 390 is defined as Li-6H, it can also include an ignitable foam of the type known in the art for enhancing explosive fusion reactions. The foam may be layered or replaced with substrates, like graphene to provide a shaped surface against which the reactions can be pushed to attain desired dimensional features at the atomic level where compression occurs.

The second reactant 445 here is contained with an insulating means 381 (typically in the prior art a foam) used for encouraging the reaction around the means 390 to both insulate the Li-6H from the first shield means 424, in place of the shield means 424, and/or to achieve stabilizing effects.

The arrangement of reactants can be changed. Means 390 may exist inside a shaped hollow wire, especially where the wire burns in the presence of the generated plasma, the ignitable wire might be means 379.

In the preferred embodiment, the plasma is generated with a microwave generator of the same type used in an oven, with conductors insulated to the point of contact with reactants along one of the conductors or around the conductors at the point(s) of contact. Other types of plasma generation known in the art may be used in place of this method. The triggering wire (means 382) and a reactant wire (means 379) hooked to a microwave generator to achieve plasma can be replaced with other means for generating plasma.

Instead of using a secondary explosive to get compression, a Li-6 core is directly exposed to the plasma and in the plasma it moves through an insulating barrier bringing the Li-6 within contact of a reactant matrix, heavy water, for exploding free Li-6 to compress the reactants and add neutrons. The simple pellet so defined is finished with a hard shell which contains the chemical explosion focusing it inwards. Additional explosives and fuels can be salted within the insulating barriers or reactants to achieve or enhance the shaping or compressive features of the explosion or other features or the reaction.

This pellet can be altered to improve the science and this simple version is only given to define a few minimal concepts of the AuT fusion reaction in terms of a pellet.

### Construction of Pellets and Using

This can involve putting a pellet as defined herein, into a magnetic field to hold protons as neutrons are pushed toward the center. Heavier info plus spinning increase to push together in center. The construction of pellets can be set out as picking the reactant(s), one or a plurality, coating the reactants with liquid foam or cutting out a chamber in dried foam and inserting, then sealing the reactants. The type of foam, density, width and shape define the order of reactants and their reaction times to maximize the desired dimensional transition.

The pellet may be exposed to salt water or other plasma accelerators. There can be mineral spirits or other non-water environment coatings for wires with water reactive Li6H.

Shaped explosive outer layers or otherwise focused charges encourage smaller pellet design.

The entire pellet can be subjected to the fields and lasers or a portion can be targeted to get the effects, but they are not treated as fields or lasers, but as fractal state modifications to a matrix to be modified, the matrix here being the pellet.

A pellet may be designed to destruct into the features desired. The makeup of different pellets and plates are varied to get the specific combinations and timed changes to modify ct states.

The entire “environment” or matrix, of the reaction at each stage is critical to its efficiency. Pushing neutrons in while allowing space to escape for fusion, using stable plasma to temporarily open states to allow for targeting the shapes for compression, concentrating the states need for compression in a series of such changes, with proper timing is necessary to maximize the reaction efficiency.

This can involve firing one or more pellets into a target or into each other.

Pulling a wire through a series of contact points with a second wire in the pellet can be used to trigger the steps with current, such wires may be insulated by the other materials of the pellet.

FIG. 35a shows the use of two accelerating means, here fueled casing 523 to accelerate pellets 522 into a plasma field 531.

The plasma field 531 here is generated by two sets of first contact means 379 contacting second contact means 382 said means connected by wire igniting means 397 and 398 connected in the preferred environment to microwave generators (not shown) to create the plasma field turning at least a portion of impact plate 525 into plasma.

In the embodiment shown pellet 392 and pellet 522 are driven together or into a target defined by plate 525 by a 22-caliber shell designated as casing 523, using a nail driver gun shown as barrel 524.

To maximize the effect the pellet is designed to maximize the effect desired. The features used depend on the reaction desired.

The pellet may be shaped, here shown as sharpened on one end, it may also be shaped as by being carbon in the form of a five sided matrix, a six sided matrix or a diamond matrix; it may be softened or hardened. The collection of these features is defined as a concentrator means 527 allow for the force to be compressed inward, to a point. These pellets can be driven into a plasma field with a reactant in it and likewise can be part of the reactant mix as shown.

Here, the concentrator means 527 is shown with bleed lines 528, 528a, 528b which may have bleed line fills 529 and 530 to encourage the release of specific ct states using filtering, electrostatic or other means. FIG. 35e shows a special case where the bleed line 528 has one part of a wire 419 which passes into the interior 477 of the concentrator means 527 to carry current from at least one direction to bring ct4t12 states into the reaction at the proper time.

Here, a shaped foam plasma means 388 provides a plasma support foam to keep the plasma in place as first secondary reactant 442 enters the plasma.

Lines 528c and 528d in impact plate 525 can also be used to encourage compression at the plate 525. Lines 528c and 528d might be open or might contain a fill such as that described relative to lines 528a and 528b.

Fill 529 and 530 may be explosive or other material to deliver sequential ct states into the matrix. To further this result, the pellet discussed here has a second concentrator 527 which is propelled into the plasma means 388 by and with second secondary reactant means 443 which here is an explosive.

A second gun barrel is shown 524a which can propel a second pellet means 392 of similar design to get increase the compression and to get at least one secondary impact. These are shown with the first pellet 392 entering plate 525 through bleed line 528d which is approximately the same size as pellet 392 and where the second pellet 522 hits a smaller opening in the bottom of the plate as the first pellet 392 reaches that point in increase concentration, perhaps associated with a renewal of the plasma state of some of the reactants.

Some variations within these elements are shown. FIG. 35b shows at least two different barrels 524 and 524a offset to bring the pellets into contact along their edges through a larger opening 528e at the top and bottom of plate 525.

FIG. 11b1 shows two additional pellets capable of being added to shape the point of contact within a larger plate 525 open to allow this effect. The number of pellets 392 and angles and edges of overlap and reactants at the points of sliding contact, forced together and their size can be modified to keep the reaction more simultaneous and to control when plasma exists and what ct states are present

The plasma field may be extended to the pellet itself as shown in FIG. 11c and FIG. 11d the pellet 392 is a foam plasma means 388. In both there is a secondary plasma generator 446 with reactants 442, 443 and 444 positions respectively within the means 388 item 443, partially embedded item 442 and on its surface item 444 so that different ct state effects can be added to the plasma as it forms and as it cools.

FIG. 11d shows two pellets of the type shown in FIG. 11d fired into a larger plasma field 531 which is within a larger plasma field to encourage the correct plasma, the reactants 444 and 443 being positions to be contacted by the pellets at various times during the collision of the pellets.

In AuT this wave function is eliminated in terms of pre-time change and KE is replaced with a change in the potential, the extent to which states are going from non-changing to changing within a matrix.

The use of “plasma guns” firing ionized gas inward to compress and heat a central gas target do not control the reactants to create stable resulting fractal interactions.

Fusion, Energy Generation

Fusion can be described as (1) expansion of outer, lower information states, (2) bringing in equivalent Ct4 information states e to create a stable core, (3) surrounding the core stabilizing lower compression states.

### Fission

Fission is more than just the opposite of Fusion. It is possible to slow down reactor container degradation by applying the concepts of AuT to reduce the energy of the gamma and alpha wave states, which are likely ct4t6 and ct3 states with a lot of pretime change which can be stripped off as energy, using the catalyst type method as a constituent part of the reactants woven into the reactants, surrounding the reactants or in any method of composite chemistry or as a part of the shielding, even as a part of rod system, as by having alternating rods for separating the pre-time states and transferring the resulting energy where it can be used to supplement the work or the reactor or for disposal.

Fission involves specialized chemicals with the same imbalances, just at a larger scale and while creating massive releases of protons to increase the speed of the reaction is only a matter of purification of the matrix, controlling the radiation and the release requires a similar finesse which can take a random reaction which generates heat as the sole benefit to one which releases chemicals which can be useful, perhaps it is even possible to get a stable reaction which receives a feed of information to allow it to remain stable and continuous.

### Types of Fusion

| Reaction | Energy | | Particles (pre-aut |
|---|---|---|---|
| H2 to N (ct3-ct4) | 1.44 | MEV | Positron, electron |
| H + D to He(ion3) (ct3-ct5) | 5.49 | MeV | Gamma rays |
| He(i3) + He(i3) to He(i4) plus 2H (ct5) | 12.86 | MeV | Light spectrum |

(1) Pre-Atomic Fusion: The P to N (H2 to N) is a ct3 to ct4 transition. In the H2 to N2 you have a helium forming, but there is less free information to start with. The process is to fill the last information arms of the proton and close the outer shell to higher “proton” ct state exchanges in favor of the lower ct states of the neutron exchange; to change the dimensional structure to a base 5/10 structure from a 3/6 structure. It is possible to create an environment of neutron short materials, those requiring more neutrons for stability to enhance fusion by providing a ct state matrix conducive to stabilize loose neutrons.

Dimensionally, the ct4 neutron is smaller, without much more information (relatively speaking) than the proton because it folds into another dimension and this change releases lower ct states otherwise a part of the proton cloud reflected by electron bundle 99 which is required for the stabilization of the proton.

(2) Hybrid Fusion: H+N to HN produces an unstable result which using the AuT model can be used to generate a continuous reaction of compression followed by decompression; the utility of such a reaction is limited.

(3) Atomic Fusion: The simplest form is Free N plus Free N to He. The most common source the free neutrons is unstable Lib. No matter how complex the atom, you have to build a backbone of Neutrons by bringing the two exposed neutron cores together, in adequate proximity to allow them to share dimensionally equivalent or dimensionally balancing spew can involve ensuring a spew/absorption matrix conducive to sharing through three layers of space (ct1-ct3) and through transitional states and balance the backbone structure with ct4t16 and ct4t12 providing balance and stability.

### Method: Fusion-Reactants

This process is preparing reactants in terms of (1) their order, and 2) compression state features (a) fuse length; (b) compressive direction (towards or away); (c) fractal state (dimensional state) components to create a reactive environment.

The design features (effectors) comprise: (1) timing (e.g. timing a step as 1:2:3 to get a spiral effect, order and types of generated reactants) (2) Quantum amount (e.g. to get a quantum change effect) (3) quantum size; (4) relative intensity; (5) shape to match the fractal desired at the current stage or next stage of the reaction (actual/virtual chambers AND reactants), (6) spiral (f-series) variation through movement of the reactants; (7) the number, (8) pressure (concentration of different ct states and amount of fuse change) (9) scale and (10) effective if not actual shape/dimensional container and effect of steps consistent with this type of modeling of fractal transitions; (11) rotation, velocity, (stability/instability) and (12) absorption and spew targeted to balance the resulting reactants for the purpose of fractal transitions.

EFFECTORS 1-Order: Ways to Accomplish Fibonacci Change:

Order varies depending on the result, but order is an issue for all reactions, so Fusion order will be explained, and it can be extrapolated using fractal modelling to get any larger or smaller reaction whether molecular or pre-time.

Sequencing order is (1) separating the reactants (e.g. electrons, protons and neutrons); (2) Preparing the reactants to interact (e.g. opening electrons and protons; bringing neutrons in sufficient concentration and energy levels to interact; (3) brining the reactants together; (4) and stabilizing the desired structures.

Order is (a) Planning (design) reactants, b) ordering reactants c) Assemble reactants in the order to be used. It is also controlling the time of reactions, the means of controlling the time of transitions between steps, the number of transitions in any steps, Fibonacci staging especially to the extent each of these features can be brought to bear at the pre-atomic level.

The Manipulation of reactants is an effect of assembling them along a reaction line. There may be multiple steps:

Fusion step 1: a) Assemble free neutrons b) manipulate the matrix to bring them close enough, so they share information to get Helium minus (two neutrons without a stabilizing shell). Step 2: a) Assemble stabilizing Proton shells, b) Manipulation is the method that leads to inserting the shells around the neutrons such as a focus on the shifting center of charge of the electron and the absorption and spew.

The invention is a method of manipulating fractal features. Planning means treating all features, including compression state, energy, force, and time, as dimension changes between ct states. This primarily involves solving for all final and intermediary features of at least two fractal states derived from at least two iterated equations, figuring out how to create them and ordering them.

Stable neutron backbones need a shell of protons (2 neutrons need two protons in helium) to have enough exchangeable and balancing information to remain stable just as the two protons needed the complete shell of electrons. The key to a fusion reaction of this type (one where you are not making neutrons, but merely building helium from existing neutrons) requires you get everything close enough in the right order for it to stabilize and that the shape of the compounds corresponds to the required rotational symmetry with stabilizing clouds for greater rotational stability or cushioned rotational stability, providing the necessary absorption and spew to allow the fusion to take hold.

A trigger for the reaction could be a plasma stream or a radioactive source delivering neutrons as a reactant. In fusion, maintaining all the reactants as a plasma is contraindicated. Manipulating the reactants would be complicated by such a process.

It is possible to sequentially control chemical reactions including fission and fusion using features from the group defined as 1) Differentiating change and time; 2) controlling time with speed; 3) dimension specific fractal shaping, fractal targeting dimensional extremes, separating ct states, targeting specific transitional states, targeting specific fractal features with (1) dimension, (2) dimensional change, (3) absorption and spew features, (4) the intermediary transitional features between fractals, including dimensional features and the like and its worth a look at traditional views to understand the scope of this.

One way to control the reaction is to run a reactant line from the center outward or inward to encourage the movement of the reaction towards or away from the center as another triggering features is applied to the line. In the preferred embodiment discussed below the reactant line is a wire connected to one end of a plasma generating microwave transformer and the other wire is merely the other end of that microwave transformer.

The invention can include at least one reaction location along a spiral of desired compression and including sending ct states of effective compression in groups or individually sequentially, or in groups where they can react. It can also include the process of taking the resulting matrix and reacting the matrix with another matrix.

Manipulating Time with Speed:

F-series changes may be obtained via 1, 3, 5 speed of rotation tied to fs of changing dimensional target; balancing quantities and features of the reaction to mimic the resulting states desired, ct1-ct3 changes are time as well as movement of the higher states.

### Fractal Fuse State (i) of Reactant

This model explains how to change the matrix of any group of ct states, to create a stream of different types of vacuum, to excite neutrons to allow them to exhibit charge characteristics without destroying them to change the atomic matrix so it can be manipulated. Fuse length can be targeted as potential vs. actual energy over a value of x for a matrix.

Antimatter reflects opposite fuse direction for a matrix. Since space is ct1-3 plus very low ct4 transitional states, anti-matter (ct states with opposite compression profiles) may be used to manipulate information including breaking down ct2-4 or removing it to increase the compression to bring the neutrons together or create the proper sharing mix of absorption and spew states to enhance reactions including fusion.

Ct State: Fractal:

This means the specific makeup of the ct states including fuse length. For example treating the proton and electron as different transitional levels of base 3 to base 4 transitions, neutrons as ct4, treating energy as “essentially” pre-time change features of sub-fractals primarily within the ct3-4 transition so you are sorting fuse state means; consolidating fuse states (energizing) means using speed levels, draining off the excess momentum, targeted changes in the informational matrix around the higher compression states. CT states as used herein include transitional ct states, at least those which are stable.

Excited protons are used to add rotational stability around the neutrons especially by way of cooperating absorption and spew with electrons added to further cushion and disperse the rotational energy. The reaction might include fast or slowing or even slow addition to allow stability while maintaining rotational symmetry to allow heat as experimentation dictates.

To create a fusion reaction, ct1,2 and 3 states are removed from between the neutrons 30 to the extent they are not shared. “space” according the standard model is ct1, ct2 and ct3 along with some lower transitional states of ct4 in AuT.

Fractal Shaping:

One method of targeting fractals is with shape. The changing structure of the reaction chamber(s) is an important aspect of this invention. surface variation, e.g. graphite surfacing to get a six-sided carbon structure, designed base states and the like can be used to enhance shape effects of the reactants. While much of the preferred embodiment deals with physical structures, the elements can be targeted using virtual chambers built from the elements as long as the structures targeted, and the resulting structures can be manipulated.

Compression (Concentration)/Decompression:

A means (pulsed plasma canons and/or laser pulsing and/or explosives) can: a) push together the neutrons and protons or pull them apart as with plasma so you have separately or together. Electromagnetism may be used to concentrate and order, especially, the protons and electrons can also push apart protons and/or electrons and bring them back together to create a compression pounding effect like a pile driver.

Compression means, isolating means, decompression means are part of this.

These can be to decrease the area to be targeted, increase the neutrons at that level, and to add stabilizing features in an order desirable. Creating negative charge to carve in a path for protons can be followed or combined with by positive charge to add a subsequent shell of electrons and even to provide rotational stability with sequential compression stability of the type required.

Compression and rotational stabilization with sequential compression (neutrons brought into proximity, balancing shells of protons and then electrons) can be enhanced by having the proper plasma energies and plasma holding foam materials and layers of foam so that the shells may be added by layer instead of or in conjunction with electromagnetic addition of information.

Pressure is at least as important and that pressures at the interface of the crust and mantle of the earth are adequate for that purpose. The fusion bomb model suggests that higher pressures and heat/energy compression are required, but there are reasons to opine that this can be dealt with because in any equation under AuT, all elements are the same. The pressure equation can be significantly altered, and this brings into play the potential for using spiral compression along with dimensional variants in pre-time space in place of intense pressure and gravity; using concentrators, such as blast resistant barriers, shaped explosives, high energy ct states (plasma canons and lasers, shaped carriers (water and water in shaped container form) f sides of a virtual chamber (e.g. by effecting a reactant (pellet) from 5 sides to get a base 5 effect.

### Compressive Direction

Moving states apart is typically done by increasing the energy levels by shining radiation, adding charge (inserting ct4t6-ct4t12 range compression, for example) at absorbed wavelengths or particulate amounts to increase operationally the amount of ct1-2 type states or adding heat and these can be moderated as to any of the involved states to maximize the results focusing on the information arms to be destabilized and expanded, sequentially if necessary. The use of compression (pressure) and vacuum can work with this process since that varies lower ct compression information within the reaction chamber.

### Destabilized Fractals

To accomplish fusion, it is necessary to manipulate these different states to destabilize and re-stabilize them and manipulate proximity.

Disrupting and Recombining:

Disrupting and recombining ct shells provides an environment where sequential Ct states of varying compression can be prepared and put into proximity with the correct balance in the correct environment and order to combine and stabilize, bringing neutrons together and building a stabilizing shell for example. Plasma generating microwave transformer or other plasma generators may be used. A more intact proton shell, perhaps expanded with lower information states or destabilized to the same effect by limiting spew, provides room for the neutrons to be contained and is more reactive. Stabilizing the shell and the resulting fractals is also indicated. Having items within the flow but outside of the plasma require cooling since few large fractal composites (fractals within fractals) can withstand the heat of the plasma since energy requires a breakdown of CT state. You can lower the heat required by the reaction by treating the reactants and making them more prone to fusion in the absence of plasma, by carrying on the reaction adjacent to the plasma yielding open components, or by allowing the plasma to cool as the sequencing occurs. Inserting excited photons (photons with short fuses) into a portion of the bundle change the structure.

Fractal Targeting Focused on Fractal Origin:

This includes reducing or increasing the amount of any ct or transitional state to encourage the reaction of the elements.

Since gravity is ct1 to 2 compression, acceleration, explosive or otherwise, directly towards or away from the center of gravity allows this ct1-ct2 fractal to be targeted. Orienting the reaction relative to existing gravity can be used to enhance spiraling together or apart. For the same reason, movement in multiple dimensions (one or more mechanical spin directions) can be used for increasing the number of changing ct1-3 states in the same way that acceleration and gravity affect time.

### Fractal Targeting Focused on Dimensional Extremes

Dimensional extremes (such as those involving pressure and vacuum) have to be imagined in terms of fractal intermediaries and results. The fractals are formed together by sharing (one example being t6) spew from electrons and absorption by the protons matrix and the cycle of information back again binds the proton and electron as well as stabilizing them, the stability of one fractal is tied to the presence of a cooperating fractal and shared information between “complete compressed states,” e.g. neutrons, allows them to stabilize each other. to remove or thin the outer clouds in Hydrogen, remove or thin the outer clouds from a neutron source (heavy hydrogen or heavy water being two likely candidates); place the neutrons within the hydrogen protons or wrap the hydrogen protons around the neutrons; and finally reintroduce stabilizing structure of lower compression states, particularly if not primarily electrons.

The number of chambers and the shape of “dimensional features” may vary to get different effects of fractal manipulation. A larger fractal chamber, such as a five-sided cube might encourage a 5:5 type alignment as the larger fractal encouraged the smaller just as the smaller dense fractals shape the outer orbitals. While the sequence would be subject to experimentation a 5:5 chamber made of walls energy (photonic or wave) or any combination of ct states for ct4 alignment, transforming through moving the reactants or reshaping the chamber to a 6:6 ratio when stabilizing protons were added as a natural progression.

CTB-Layering:

Reactants may be placed in layers. Layering is used to obtain sequential compression and decompression, to get sequential shaped changes, to get sequential fractal, f-series effects (using separation, thickness, concentration, mixed materials, gradually changing versus rapidly changing materials to encourage reaction, separation, absorption and spew and combinations thereof); to get different materials for the fusion process, including plasmas; to hold in heat until compression can be initiated or to stabilize the reactants (and/or) until stabilizing other states can be added (or to add them); to get linear changes along lines of reaction and the like; rotational elements to work with the absorption and spew to increase stability of the resulting fused materials. Durability (through thickness, length, concentration, material, reaction time) of layers is important to mimicking ct state changes, time must be balanced with pre-time changes, a pellet system is the concentration in place of a sequential system where the pellet has all the features of the reaction built into it which can include the shape of the surfaces on which the reaction elements are placed or where plasma reactions occur. The types (qualities) of purities or impurities in any given layer, including the makeup of voids, change the layers, a void being ct state components is subject to more variation and may be used to create implosion (vacuum) of various compression types.

CT State: Balancing:

Just as bringing two galaxies together to form one might require exposing the galactic cores, this process requires controlling the momentum, by balancing the outer less compressed states including the holding matrix or medium at each step must be designed with an eye towards stabilizing or destabilizing absorption and spew. One can “salt” a mixture or matrix with features that will (naturally or upon destabilization) yield stabilizing and destabilizing features. Proximity with orbital stabilizing movement with appropriate stabilizing absorption and spew fractally balanced structures. Neutrons need to be mixed, lured, and/or pounded into proximity so they can enter the stabilizing proton shell without disrupting the stabilizing fractals. “Beams of neutrons” added to expanded ct4 neutron cores and bathing the resulting combination in the type of ct states which would stabilize more compressed cores (more neutrons) or better cores (e.g. Helium from Lithium six, for example); providing the necessary absorption and spew to allow the fusion to take hold. The start is concentrate neutrons, providing an environment with sufficient balancing can be accomplished with heating to plasma, then controlled cooling in an environment to accomplish the stable symmetry with balancing, ct disrupter absorbing states for organizing the matrix resulting with bilateral symmetry corresponding to the resulting fractal structures desired.

Spiraling

Spiraling around an interior of a pellet to encourage spiral effects, effects which spiral reactants, for example neutrons (and/or other lesser compression states) is conducive to balancing in fusion. This is also an aspect of rotation at some or all stages of the reaction including sufficient rotation to achieve pressures against barriers which can be supplemented. Actual spin can be used to create a spiraling means for creating rotational symmetry as well as reducing the amount of time within the system. Spiraled chambers and mimicking spiraling, such as changing dimensions, reaction times, pressures and the like in the same scale as the changing spirals (1,2,3,5; 5,3,2,1 for example) and even the various types of vacuum in the center or other locations of the reaction. Spew and absorption of a given range is the equivalent of the rotational stability sought within a fusing matrix. Swirling at the right rate of change with a matrix encourages an end fractal result.

CTA-Separation of Different Ct States:

The separation of lower states by the next higher state remains critical. Separation is tied to compression state. If enough ct1 is eliminated between ct4 states, then they would form the next transitional ct4-5 state. Electromagnetism approaches the strong force 10\hat{ }36 at close range because it requires the proton and electron interaction.

Fission type reactions can be enhanced by separating the neutrons and their proton shells at the proper fractal connections to encourage formation of separate stable isotopes and shaping the reaction to match those resulting shapes can enhance the transition and control or capture the resulting “radiation” by focusing on the dimensional changes instead time based energy aspects.

Another way is to mix the elements, for example using ionized hydrogen (to give charge) cycled through the neutrons, with cycled electrons and cycled fields (ct3-4 low transition states) to allow near collisions of neutrons to occur in a mix that is stabilizing and encourage stable neutron information sharing

CT State: Fractal Matrix Options; Absorption and Spew:

Absorption and spew control expanding (destabilizing), contracting, change rate (rising or slowing) stable or unstable intermediary states. The tighter the internal sharing of absorption and spew the harder and stronger the bond, so bonds can be controlled (made more or less reactive) by organization of the absorption and spew in the structure. This is manipulating exterior information along the fractal matrix and stabilizing the core with required sharing including fuse state with states external to the core (e.g. a neutron). Vacuum under the model is manipulatable as more than space, it is ct1 and ct2 as gravity and anti-gravity. It is ct2 and ct3 as denser form of velocity and a transition of pre-dimensional and pre-time states from those with dimension and time. It is ct3 and transitional states of ct4 as energy and time and vacuum energy and so much more. All of these are absorbed and spewed from the larger states, except to the extent that spew is limited by particulate size, too dense to be absorbed.

Material Manipulation-Chemistry

The neutron backbone model allows for the creation of larger, more balanced, less balanced, more reactive molecules. Fusion and fission involve tapping the strong force at the folding and unfolding of ct4-ct5 transitional states, but the combination of ct4 and ct5 states is chemistry.

An example of material manipulation would be to slow the degradation of the containment vessels in fission reactors by targeting the fractal features of the reaction and reactor core. Targeting reactions based on AuT features will improve reactions, energy generation the movement of resulting fractals.

Quantum Computing

The photon as a concept can be ct12, reflecting its ability to be added and raise the energy of an electron, a ct4 which is small enough and ct6 which appears more like a different, neutrino state; but these pre-electron elements are worth considering for the relative significance.

The use of faster than light communication between particles which share folded information states provides a potential carrier for faster than light communication between tied particles, including the t12 states making up electrons, primarily the lower states making up t12 states.

Using the Effector parameters (e.g. pulsing plasma, charge, dimensional effect, compressive effect, decompressive effect, etc) the number of times can correspond to the state desired as a function of f-series of compression series steps and dimensional changes as desired including transitional states desirable to the reaction in question.

The process may accelerate the entire pellet within a field (to reduce time components); with or without rotation (as with rifling) to give rotational stability to change the features of the pellet as it is accelerated towards a target. Collision can be used to enhance compression and shape and balance.

Pulsed plasma may be used in place of constant plasma because of plasma's limited purpose. The purpose for spin inducing through whatever means is discussed in more detail with respect to other drawings, but the key is to eliminate pre-time states to allow compression to occur more easily and/or to encourage balance of the resulting states.

Shaped charge means for shaping the post plasma reactants may be actual explosive charges and may stabilize and possible spin by targeting the plasma at an angle. These could initiate the reaction by firing along the line of the spindle and being aligned and then offset, pulses of plasma. They can also pulse electromagnetic radiation and/or excited electrons to help balance the resulting transition and complete ct state.

Some of the effects in this system are to (1) stage plasma to separate and energize reactants at different points in the reaction, collapse or expand the reactants, increase the richness relative to neutrons, protons and electrons in the sequence desired as well as lower states at different points in the reaction and change the amount of time/lower ct state changes by accelerating pressure and heat.

While this shows reaction from the inside out, out reactions could work from the outside in as is discussed with other pellet designs.

The preferred arm layout is to allow loading of pellets with grooves to get alignment supplemented with magnets, pathways to target and control movement and timing of expanding and compressing steps, alternating compression and decompression, pulsing of plasma, cooling, spinning, controlling dimensional shape, timing steps, enhancing the absorption and spew environment and reactant components and exerting varying Intensity, timing, amount, concentration, volume of the energies and reactants involved to provide desired f-series effects.

The use of centrifuge (speed pressure in place of gravity) is discussed in more detail relative to other drawings.

Current to control the movement of the protons and electrons which, being charged, can be directed in this way.

Where spirals and specific chamber dimensions are not possible, it may be possible using shaped reactants, sized reactants, spaced reactants, shaped spacing, timed compression, timed decompression, timed application of plasma and the like to simulate an order which might be opposite shown and extremes that encourage the type of quantum fractal transitions that should be obtainable in terms of both imparting rotational and compression oriented stabilization necessary to get fusion.

A shaped surface may be provided against which reactants may be driven or from which they may be drawn to encourage the geometry desired.

Manipulation is broadly considered, and can come from the idea of targeting fractal relationship in the reaction or fundamental change of the universe, to predict the future or prepare future results, which term targeting is a way to include the group comprising: (1) treating energy as information change between pre-time and post time effects; (2) manipulating alternatively trapped states, transitional states, hinge states and compression states to effect dimensional changes; (3) treating space as a series of dimensional compression states; (4) treating dimensional/base number features as fractals defined by the fractal iterated equations giving rise to the dimensional states; (5) comparing one or more fractals, (6) targeting relationships between fractals; (7) targeting fractal changes for energy generation, quantum computing, transportation, material manipulation or a combination of those; (8) changing information states (ct states) by changing a feature, especially absorption, spew, compression, decompression states, time and pre-time states of at least one fractal component ct state; (9) compressing states and decompressing states along spiral fractal lines; (10) tapping spew or absorption states for energy; utilizing pre or post time change to deal with dimensional features for desired reactions; controlling absorption and spew states to control compression and decompression of associated dimensional states; treating time only as an effect replaced in all manipulative equations; or controlling time by controlling ct state substitution. (11) establishing a matrix and changing regional concentration of states in the matrix; (12) stabilizing or destabilizing ct states by adding or removing lower ct states from a higher compression (virtual) information arm; (13 treating wavelengths as the expression of pre-time quantum dimensional change; (14) balancing time and non-time elements for maximum efficiency, for energy generation, transmission, chemical or electrical reactions, (15) manipulating Quantum change ct states; (16) identifying point of transition from net compression to net decompression for a ct state; and transitioning between the two adding or removing lower ct states transitioning at a different level, especially for quantum computing; (17) filling, breaking or emptying fractals within fractals; (18) sharing at least one outer compression state of each of two ct states; (19) treating electrical energy as net spew of AuT information from the electron to the proton in terms of pre-time absorption and spew of at least one specific transitional states, (20) using dimensional changes including at least one feature from the group comprised of: charge, fuse length of one or more ct states, (21) averaging ct state features to estimate ct state features; (22) removing compressed states from a matrix to change other states in the matrix (23) manipulating features as non-3-dimensional features using gradations of ct states in place of dimensions; (24) manipulating dimensional features as fractal spiral strands of ct states; (25) treating force and time as effects of dimensional change; (26) treating dimensions as different base states where ct and base states equal both complete and transitional ct states; (27) changing selectively base state features as odd and even exponential features; (28) changing a fractal, dimension, ct state feature, component, for a region defined by fractal stabilizing features, (29) using at least one coexisting ct state to effect opposite ct states, (30) defining energy in terms of pre-time changes in a region; (31) creating velocity from the folding and unfolding of ct states; (32) creating velocity comprising the steps of: Identifying a first mass comprised of at least one ct3-ct4 transition state and a second mass comprised of at least one first intervening ct state and a least one second ct state where intervening refers to the folded order of location between the two states; converting the intervening at least one ct state, folding within another lower or higher ct state; (33) storing energy based on pre-time and post time features of the material involved; (34) maximizing dimensional efficiencies comprising the steps of: minimizing transitional vibrational features conflicting with the desired transitions; (35) maximizing results based on AuT features of the affected dimensional states; (36) utilizing elements of time independent change; folding or unfolding; location of folding and unfolding; or combinations of those; (37) creating charge changes, rate of charge change or other ct state movement changes comprising the step of controlling the distance between at least two different matrix based on the AuT features of the separating matrix; (38) generating either a winding or unwinding of space to get fusion or fission or to enhance those reactions; (39) compressing space or releasing the trapped non-dimensional space to manipulate gravity; (40) generating energy from selectively targeting compression or hinge states; (41) generating energy storage with dimensional changes; (42) separating states by affecting the hinge states in particular to break it up; (43) correcting quantum results for ct changes within a matrix; (44) providing for the changes based on expected compression or decompression solutions in one or more of the quantum states in question; (45) treating all increasing dimensions as increasing compression, not expansion despite this being counter-intuitive; (46) Destabilizing fractals to drain energy or stabilizing groups of fractals to release extra energy in either case as lower compression ct states.

The process of exposing or modifying the cores of atomic and molecular matrix can come in several forms: (1) changing; decreasing or increasing the ratio of lower transitional states to neutrons within the matrix, (2) changing the nature of absorption and spew of the different matrix of reactants as by (a) increasing the amount of lower transitional states around them, (b) removing transitional states around them or around one side of them and (c) it is to target the center of charge (abs/spew) or areas offset from the center of charge of any reactant or the different matrix or sub-matrix within the reaction to (a) lift back the outer shells or (b) close back the outer shells around the more compressed cores within the matrix, so that the additional steps can be carried out. A method for changing dimensional states comprising the steps of 1) Determining lengths and/or corresponding areas of different ct states; determining the fill for each area, determining the number of applicable ct states that can be included within the areas; alter the ct states by altering the ct state mix within the matrix. The similarity with, for example, cellular attack by a bacteria reflects life arising from fractal states, in life and beyond to black holes reflect underlying processes allowing human treatments to be manipulated by targeting these fractal relationships.

Fusion

The process of exposing compression cores including collapsed whole cores and partially collapsed transitional cores can be controlled by (1) increasing or (2) decreasing the concentration of lower transitional states around a core which requires a certain absorption and spew for stability.

A method of practicing fusion for proton and electron shells comprising the steps of (1) lifting back the electron and proton outer shells around the neutron cores of two neutrons to be fused, (2) lifting back the electron shells around at least two proton cores; (3) separating at least two protons, (3) bringing the two neutron cores together; (4) inserting the neutron cores between the separated protons to form a new neutron core and (5) closing the proton and electron outer shells around the new neutron core (adding the type and amounts of ct states necessary to stabilize the new core) according to the fractal model taught herein.

The method is a method of setting up or obtaining hot fusion, targeting the fractal features of the reaction. In observed fusion, extreme pressure is used, typically from high gravity or from the ignition of a fission bomb. While the effects must be similar, a fractal approach means at the quantum level, no energy exists and gravity is isolated as folding at the ct1-ct2 level so that by design the fractal features of intense pressure can be established without radical effects.

In principle the process is to fix the pieces in place, open the “wound” in the nascent neutron, as with plasma, push or draw in the positron, to the extent out of place, the outside shared information, and the electron, opening the proton shells around them to insert around paired neutrons to create stable backbones where the neutron cores pull together stabilized by the surrounding lower ct states with a common outer group of stabilizing surrounding lower compression states. then balance with an electron, and then stabilize the resulting neutron with a proton shell stabilized in turn with electrons

Quantum Computing

For quantum computing change and time can be treated as results of the application of two fractal equations for a use from the group selected from, comparing, computing, and, targeting relationship between ct states for predictive purposes. In this case the method includes communication over spirals with pretime information for faster than light communications using fractal designs. The method includes comparing to what is observed otherwise to determine what is going on in the pre-time environment.

A better qubit is found in the individual ct4t12 states which are exponentially more pretime within the electron qubit just as treating the qubits multiple states at once as multiple states within a series of pre-time changes gives a better quantum result and where averaging these changes within a field as shown, monitoring it and maintaining the results should give better computing results related to pre-time change.

Since we know that t12 states make up the quantum bits of flow, we can build a quantum computer of t12 qubits by inserting within the flow another (intermittent possibly) flow and watch the changes as they are disrupted and go back together at the quantum level.

Chemistry

A method to design atoms or molecules comprising viewing the atom as a fractal according to a fractal model and wherein that method includes making them harder or softer, more or less energetic, and using different intermediary arrangements of information states.

A method to model and control both atomic and molecular reactions along fractal layouts and by targeting the building or destruction of fractal elements.

The method includes maximizing fractal structures including fractal building blocks, such as Argon, Carbon and Helium blocks, and extensions off the fractals including how they snap together with shared information for maximizing efficiencies in atomic and molecular interactions; Targeting these building blocks, both complete (noble gases) and incomplete, is a major advance made possible by this model, including spiraling information to stabilize or destabilize a matrix; Changing a field to create spiraling using multiple inputs to disrupt and shape the fields.

### Structures

Magnetically shaped chamber. Primary magnetic field without much shaping (e.g. round) and use secondary fields to break up or shape the main field to create pretime circuits.

1. A process for dimensional manipulation comprising the steps of (1) defining dimensional features as ct states defined by at least one iterated equation which separates compressing ct states from decompressing ct states wherein compressing is towards higher dimensional features and decompressing is the movement from higher dimensional features to lower dimensional features; (2) identifying a matrix containing a plurality of “ct states” and (3) changing at least one ct state to alter at least one dimensional feature of the matrix.

2. The process of claim 1 wherein the at least one iterated equation is at least one non-dimensional iterated equation generating quantum ct states and wherein compressing quantum ct states yields compressed ct states and lower compressed ct states between at least one of the compressed ct states and the quantum ct states.

3. The process of claim 1 wherein the at least one non-dimensional iterated equation generates the quantum informational states which change between positive and negative values according to a quantum count with a fuse length for each quantum ct state, a net compression for each compressed ct state, and an inflection point for each compressed ct state where each compressed ct state changes between compressing and decompressing.

4. The process of claim 3 wherein the matrix change is absorption where the matrix becomes more compressed and the matrix change is spew as the matrix becomes less compressed.

5. The process of claim 4 wherein compression further comprises balancing compressed ct states on a fulcrum comprised of shared lower ct states from at least two higher ct states as Fibonacci series spiral solutions of the at least 2 compressed ct states.

6. The process of claim 5 wherein balancing further comprises successively lower ct states within the spiral solutions of successively higher compression lower ct states to balance the compressed higher ct states.

7. The process of claim 6 wherein balancing is further defined by balancing absorption of spew of ct states between compressed ct states and where targeting further comprises targeting the absorption and spew of the matrix, targeting shared information between compressed states, or targeting both.

8. The process of claim 7 wherein balancing along a fulcrum spirals further comprises (1) defining the electron shell as a third outer spiral, balanced on inner spirals of a proton outer shells as a second outer spiral, around the neutron cores sharing information as a fulcrum between the two neutrons and from which extends the first inner spiral to form and stabilize a neutron core in a molecular fusion reaction.

9. The process of claim 8 wherein balancing comprises opening at least one of the spirals using plasma before the spirals balance.

10. The process of claim 7 wherein balancing comprises creating conditions to encourage balancing.

11. The process of claim 7 wherein balancing comprises determining a set of resulting ct states desired, determining a plurality of reactant ct states based on the resulting ct states; and changing the reactant ct states to obtain the resulting ct states.

12. The process of claim 4 wherein the at least one non-dimensional iterated equation is fpix, the denominator of pi, and wherein the change in value occurs after the quantum value equals the value of fpix for the ct state's fpix value immediately preceding the change in value and corresponds to the value as a new fpix value for the fuse for the lowest used ct state.

13. The process of claim 8 comprises at least one compression iterated equation derived from the Fibonacci series.

14. The process of claim 9 wherein the compression iterated equation has an exponential result.

15. The process of claim 10 wherein ct states further comprise stepped compression between iterated equation solutions as transitional ct states between ct states defined by successive iterated equation solutions.

16. The process of claim 10 wherein the compression iterated equation is comprised of 2f(n)\hat{ }(2\hat{ }n) where f(n) in the Fibonacci number for n.

17. The process of claim 14 wherein ct states at the level where energy becomes apparent are treated as a transition between pre-time ct states and post-time ct states and wherein changing comprises treating time as change in the pre-time ct states viewed from the post time ct states.

18. The process of claim 17 wherein changing further comprises treating energy as pre-time dimensional change within the matrix.

19. The process of claim 24 wherein changing comes from the group comprising removing ct states (as for observation), compressing, decompressing, increasing ct states within the matrix (as by combining two matrix), changing the net fuse length of the matrix, changing the absorption of the matrix, changing the spew of the matrix and identifying a ct state as an identified ct state within the matrix and changing the ct states making up the identified ct state.

20. The process of claim 24 wherein changing comprises a change from the group of processes comprising identifying the ct states which are to be manipulated, select a compression or decompression ct state component to change the selected ct states, adding the compression or decompression components to yield the new ct states controlling time within the matrix, quantum computing, determining probability of state changes, manipulating energy, identifying qubits, identifying qubit pre-time states, creating qubits, reading qubits, manipulating qubits, pre-atomic fusion, atomic fusion, atomic manipulation, molecular manipulation, post molecular material manipulation; identifying or changing force features; changing multi-dimensional fractals of different fractal compression states within the matrix; changing base states where fractal is made of a base state, ignoring dimensional curvature; targeting relationships between the pretime and post-time features, controlling ct states, targeting at least two ct states sequentially.
